(19) United States
(12) Patent Application Publication
(10) Pub. No.: US 2007/0152116 A1
(43) Pub. Date: Jul. 5, 2007

(54) Ball head

(76) Inventor: Larry Shawn Madsen, Colorado Srings, CO (US)

Correspondence Address: LAW OFFICE OF DALE B. HALLING, LLC, 655 SOUTHPOINTE CT, SUITE 100, COLORADO SPRINGS, CO, 80906, US

(21) Appl. No.: 11/636,771

(22) Filed: Dec. 11, 2006

Related U.S. Application Data
(60) Provisional application No. 60/756,519, filed on Jan. 5, 2006.

(51) Int. Cl. F16M 11/02

(52) U.S. Cl. 248/181.1

(57) ABSTRACT

A ball head has a ball with a single adjustment actuator. The single adjustment actuator has a locking mechanism that is low force high friction device. The locking mechanism supports a ball and socket gimbal mechanism with a fixed spherical contact zone built into the housing and a moveable spherical contact ring.

### RELATED APPLICATIONS

The present invention claims priority on provisional patent application, Ser. No. 60/756,519, filed on Jan. 5, 2006, entitled “Madsen Lock” and is hereby incorporated by reference.

### FIELD OF THE INVENTION

The present invention relates generally to the field of swivel mechanisms for holding cameras and other equipment and more particularly to a ball head.

### BACKGROUND OF THE INVENTION

There have been numerous devices for holding cameras. Normally, when a photographer wants to take a picture without holding the camera they have a tripod system on which the camera is mounted. The tripod system includes a tripod and a ball head with a platform. The ball head allows the platform to be adjusted so that the photographer can frame the picture. Normally, the ball head requires two or more radial locking actuators to separately secure both the vertical and horizontal planes of motion. When the ball head has two or more locking actuators, it can be difficult for the photographer to change the position of the camera. This makes the device cumbersome and time consuming. A ball head with a single locking actuator has been built, but it required a large amount of force be applied to the locking actuator to hold the ball in place. This made the ball head difficult to use, thus defeating the purpose of a single locking actuator.

Thus there exists a need for ball head with a single locking actuator that is easy to use and does not require a large amount of force on the actuator to hold the ball in place.

Note that while the invention is described with respect to cameras the invention is not limited to this application and the invention may be used for holding any item that needs to be easily and quickly repositioned and then locked into place.

### SUMMARY OF INVENTION

A ball head that overcomes these and other problems has a ball with a single adjustment actuator. The single adjustment actuator has a locking mechanism that is a low force, high friction device. The locking mechanism supports a ball and socket gimbal mechanism with a fixed spherical contact zone built into the housing and a moveable spherical contact ring. The forces exerted by the mechanism on the wide spherical contact surfaces provides pressure on the ball that can be easily adjusted for various weights and locking friction, dependent on the needs product to be supported.

### BRIEF DESCRIPTION OF THE DRAWINGS

FIG. 1 is a top left perspective view of a ball head and platform in accordance with one embodiment of the invention;

FIG. 2 is a side view of the ball head and platform in accordance with one embodiment of the invention;

FIG. 3 is a cross sectional view along the A-A line of FIG. 2 of the ball head and platform in accordance with one embodiment of the invention; and

FIG. 4 is an exploded view of the ball head and platform in accordance with one embodiment of the invention.

### DETAILED DESCRIPTION OF THE DRAWINGS

The present invention is related to a low force high friction ball head. Ball heads are used in a variety of applications including holding a camera on a tripod. The ball head described herein has a single locking actuator. The locking mechanism of the actuator supports a ball and socket gimbal mechanism with a fixed spherical contact zone built into the housing and a moveable spherical contact ring. The forces exerted by the mechanism on the wide spherical contact surfaces provides pressure on the ball that can be easily adjusted for various weights and locking friction, dependent on the needs product to be supported.

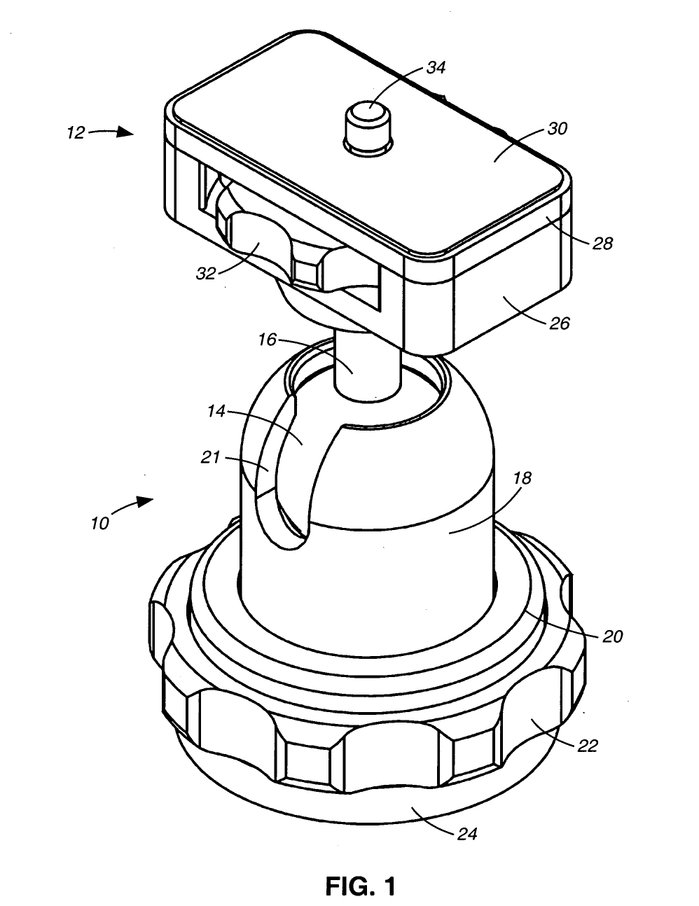

FIG. 1 is a top left perspective view of a ball head 10 and platform 12 in accordance with one embodiment of the invention. Commonly, a camera or other device is mounted to the platform and the ball head is mounted to a tripod. The ball head 10 has a ball 14 attached to a stem 16 that connects to the platform 12. The ball 14 is contained in a ball housing 18. The ball housing 18 has a single vertical slot 20. The ball housing 18 had a first end encased by a support 20. Below the support 20 is a single locking ring or actuator 22. Below the locking ring 22 is base 24.

The platform 12 has a support housing 26 attached to the stem 16. A housing cap 28 fits on top of the support housing 26. An equipment pad 30 sits on the housing cap 28. Between the support housing 26 and the housing cap 28 is a fastener ring 32. A fastener stud 34 extends through the equipment pad 30.

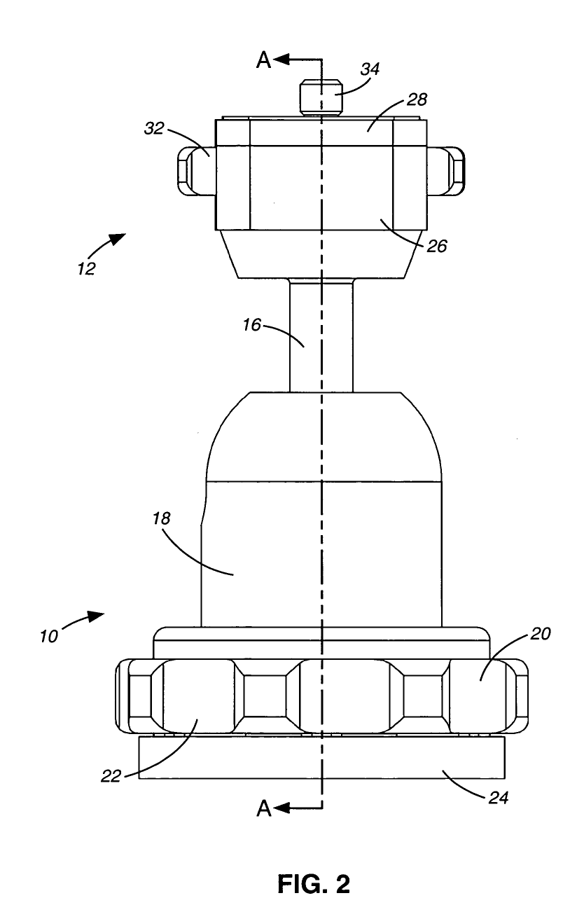

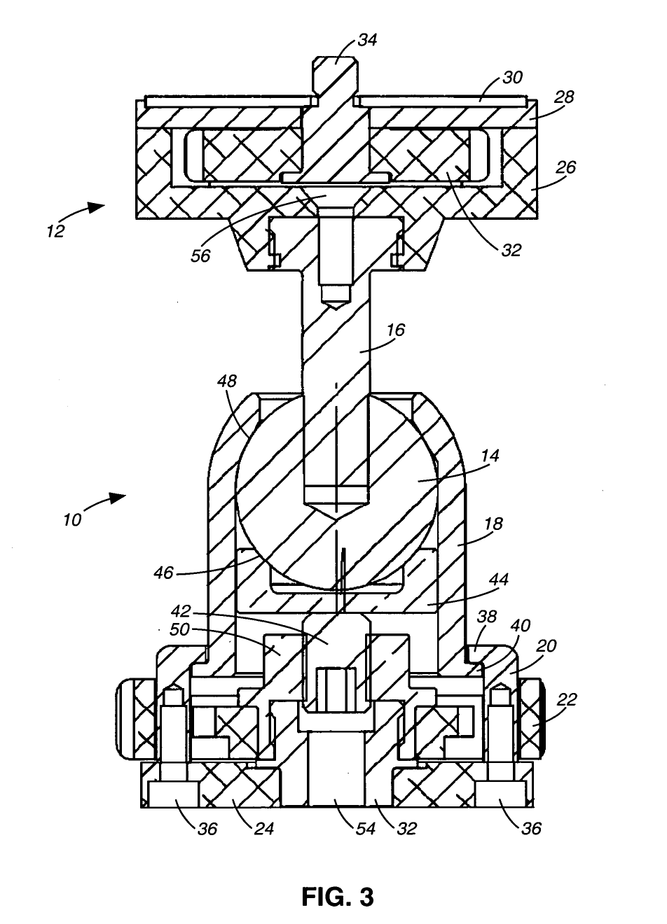

FIG. 2 is a side view of the ball head 10 and platform 12 in accordance with one embodiment of the invention. This view is similar to that shown in FIG. 1. FIG. 3 is a cross sectional view along the A-A line of FIG. 2 of the ball head 10 and platform 12 in accordance with one embodiment of the invention. This figure shows how bolts 36 are used to secure the base 24 to the support 20. The support 20 has a flange 38 that engages the flange 40 of the ball housing 18. The base 24 then holds the assembly in place. The assembly includes a set screw 42 that pushes against a base of a ball seat 44. The ball seat 44 is shaped like a cup with a matching spherical lip 46 that is in contact with exterior surface of the ball 14. The top of the ball housing 14 is beveled and the internal surface 48 matches the external surface of the ball 14. The set screw 42 is attached to a female fitting 50 and attached to the locking ring 22. A female fitting 50 rides on a male fitting 52. The male fitting 52 has a threaded orifice 54 that commonly engages a post of a tripod. The stem 16 is fastened to the support housing 26 of the platform 12 by a fastener 56.

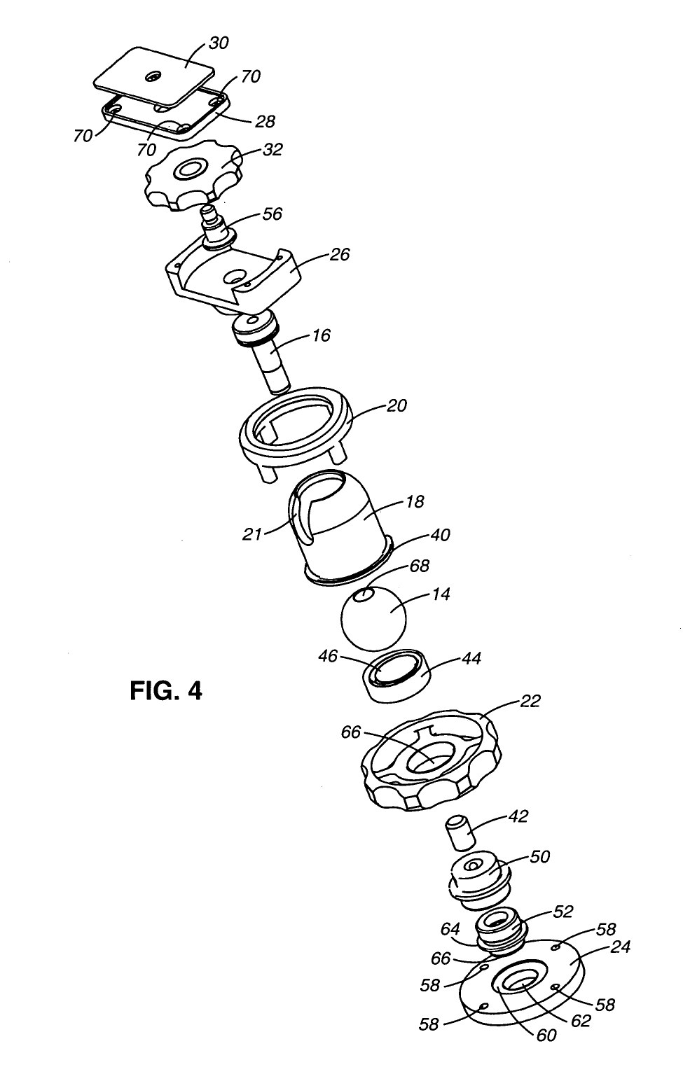

An understanding of the construction of the ball head 10 and platform 12 is aided by the view of FIG. 4. FIG. 4 is an exploded view of the ball head 10 and platform 12 in accordance with one embodiment of the invention. Starting at the bottom of the figure is the base 24, which has a plurality of holes 58 through which the bolts 36 fit. The base 24 has an annular slot 60 with a hole 62 into which the male fitting 52 fits. The male fitting 52 has an annular flange 64 that engages the slot 60. The lower stem 66 of the female male fitting 52 includes the threaded orifice 54. The female male fitting 52 engages the male female fitting 50. The male female fitting 50 frictionally engages the orifice 66 of the locking ring 22. This friction fitting is a tight fitting so that there is no slipping between the locking ring 22 and the male female fitting 50. The set screw 42 screws into the male fitting 50. The base of the ball seat 44 has a base that sits on the top of the set screw 42. The ball 14 sits against the matching spherical lip 46 of the ball seat 44. The ball housing 18 contains the ball 14. The ball 14 has a slot hole 68 that engages the stem 16. The support 20 fits over the ball housing 18 and engages the flange 40 of the ball housing 18. The stem 16 engages fastener 56, which is frictionally attached to the support housing 26. The fastener ring 32 sits on the fastener 56. The housing cap 28 has four holes 70 though which bolts extend to attach the housing cap 28 to the support housing 26. A soft pad fits over the housing cap 28 and forms the equipment pad 30.

In operation, a small rotation of the locking ring 22 turns the female fitting 50 on the male fitting 52 pushing the forcing screw 42 against the ball seat 44. The upward motion of the ball seat 44 produces frictional locking of the ball 14 between the ball housing 18 and the ball seat 44. The spherically shaped ball seats formed into the ball housing 18 and the ball seat 44 ensure a high-friction low force clamping action that holds the ball tight using a single actuator, the locking ring 22. The same spherical ball seats also permit a smooth rotating a pivoting action of the ball 14 when the locking ring 22 is loosened.

Note that while the invention is described with a locking ring other locking actuators may be used. In addition, the invention may be used with a variety of different platforms 12, which will be apparent to those skilled in the art.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A ball head, comprising:
a ball with a stem;
a ball housing having a beveled end with an interior surface that matches the exterior surface of the ball; and
a ball locking mechanism attached to a non-beveled end of the ball housing.

2. The ball head of claim 1, wherein the ball locking mechanism includes a locking actuator and a ball seat that engages the ball.

3. The ball head of claim 2, wherein the ball seat has a mating surface that matches the exterior surface of the ball.

4. The ball head of claim 2, wherein the ball seat has a cup shape with an interior spherical matching lip.

5. The ball head of claim 2 wherein the locking actuator includes a forcing set screw in contact with the ball seat.

6. The ball head of claim 5, further including a locking ring that rotates the forcing set screw.

7. The ball head of claim 6, further including a mounting platform coupled to an end of the stem.

8. A ball head comprising:
a ball
a ball seat with a mating surface that matches an exterior surface of the ball; and
a ball housing that contains the ball and the ball seat.

9. The ball head of claim 8, wherein the ball seat has a cup shape with an interior spherical matching lip.

10. The ball head of claim 9, further including a locking acuator.

11. The ball head of claim 10, wherein the locking actuator includes a forcing set screw in contact with the ball seat.

12. The ball head of claim 11, further including a locking ring that rotates the forcing set screw.

13. The ball head of claim 8, further including a stem attached to the ball.

14. The ball head of claim 13, further including a mounting platform attached to the stem.

15. A ball head, comprising:
a ball; and
a single adjustment actuator locking the ball in a selectable position.

16. The ball head of claim 15, wherein the single adjustment actuator includes a locking mechanism.

17. The ball head of claim 16, wherein the locking mechanism is a low force high friction device.

18. The ball head of claim 17, wherein the ball has a stem.

19. The ball head of claim 18, further including a platform attached to the stem.
